(19) United States
(12) Patent Application Publication
(10) Pub. No.: US 2022/0114900 A1
(43) Pub. Date: Apr. 14, 2022

(54) ARTIFICIAL INTELLIGENCE AND DISPARATE DATA SOURCES FOR GENERATING PERSONALIZED LEARNING EXPERIENCES

(71) Applicant: Veeko, Inc., Hillsborough, CA (US)

(72) Inventors: James Zhiping Qiu, San Ramon, CA (US); Zheng Wang, Bloomingburg, NY (US); Aaron Michael Wang, Corona, CA (US); Wenyuan Zhao, Middletown, NY (US)

(21) Appl. No.: 17/495,886

(22) Filed: Oct. 7, 2021

Related U.S. Application Data
(60) Provisional application No. 63/090,881, filed on Oct. 13, 2020.

(51) Int. Cl. G09B 5/14; G09B 7/02; G06N 3/02

(52) U.S. Cl. CPC G09B 5/14; G06N 3/02; G09B 7/02

(57) ABSTRACT

Generating a personalized learning experience using artificial intelligence and disparate data sources is described. A computing device is directed to identify a plurality of objectives for a user profile to meet in association with a learning course, identify a plurality of learning resources associated with the learning course, and identify information associated with the user profile. The computing device then executes an artificial intelligence routine using the information associated with the user profile, the plurality of learning resources, and the plurality of objectives that generates a customized course for the user profile. The customized course for the user profile is different than courses customized for other user profiles. The customized course is presented in a user portal for the user profile. The customized course as generated includes a subset of the learning modules curated for the user profile and an order assigned to the user profile for completion.

### CROSS-REFERENCE TO RELATED APPLICATION

This application claims the benefit of and priority to U.S. Provisional Application No. 63/090,881 filed Oct. 13, 2020, entitled “GENERATING PERSONALIZED LEARNING EXPERIENCES USING ARTIFICIAL INTELLIGENCE AND DISPARATE DATA SOURCES,” the contents of which are incorporated by reference in their entirety herein.

### BACKGROUND

For decades, on-campus education systems applied traditional school education techniques without any breakthroughs or innovation. Traditional on-campus education systems are utilized to mass-produce graduates and provide knowledge, technology, and trained labor to society. While on-campus education tends to be the primary form of learning, it is restricted to learning resources within the campus boundary. Such learning resources include teachers, books in the library, tutors, etc. The on-campus education system focuses on producing graduates in scale, rather than providing an individualized learning experience to an individual student according to his or her aptitude.

With the advent of various technologies, online learning has grown rapidly in the past ten years. However, current online learning platforms and software only rework on-campus courses to become accessible via the Internet, for example, to facilitate remote learning. It takes away the most critical element from the learning process, namely, campus advisory pedagogy and interactive learning experiences.

### BRIEF SUMMARY OF THE INVENTION

Various embodiments are disclosed for generating personalized learning experiences using artificial intelligence and disparate data sources. A computing environment includes at least one computing device directed to identify objectives for a user profile to meet in association with a learning course, identify learning resources associated with the learning course, identify information associated with the user profile, and invoke an artificial intelligence routine using the information associated with the user profile, the learning resources, and the objectives that generates a customized course for the user profile. As can be appreciated, the customized course for a particular user profile (e.g., a particular student) can be different than courses customized for other user profiles (e.g., other students). The customized course can be presented in a user portal for the user profile. The customized course as generated can include a subset of the learning modules curated for the user profile (e.g., the particular student) as well as an order for the user profile to complete the learning modules.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a networked environment having an expert advisory service and a boundless library service according to various embodiments of the present disclosure.

FIG. 2 is a schematic diagram showing a high level overview of embodiments of the computing environment that can support a student's general pre-class, in-class, and after-class processes.

FIG. 3 is a schematic diagram showing differences between the existing state of education relative to the computing environment that disrupts the existing state.

FIG. 4 is a schematic diagram showing differences between the existing state of education relative to the computing environment in purchasing an online course.

FIG. 5 is a schematic diagram showing an expert advisor service being embedded in a general learning process and configured to provide a full range of services for students.

FIG. 6 describes how the expert advisory system helps learners set up their own learning goals/directions.

FIG. 7 explains in detail how the expert advisory system is combined with the resource library to perfectly help learners choose courses that suit them.

FIG. 8 describes how the expert advisory system is implemented to monitor the learning progress.

FIG. 9 describes what the resource library includes and some typical application scenarios of it.

FIG. 10 summarizes a resource library and its technical infrastructure.

FIG. 11 is a flowchart illustrating one example of functionality implemented as portions of an expert advisory service and a boundless library service executed in a computing environment in the networked environment of FIG. 1 according to various embodiments of the present disclosure.

FIG. 12 is a schematic block diagram that provides one example illustration of a computing environment employed in the networked environment of FIG. 1 according to various embodiments of the present disclosure.

FIG. 13 is a diagram that provides one example illustration of an artificial intelligence routine employed in the networked environment of FIG. 1 according to various embodiments of the present disclosure.

### DETAILED DESCRIPTION

Various embodiments are disclosed for generating personalized learning experiences using artificial intelligence and disparate data sources. As noted above, with the advent of various technologies, online learning has grown rapidly in the past ten years. However, current online learning platforms and software only rework on-campus courses to become accessible via the Internet, for instance, to facilitate remote learning. Current solutions take away the most critical element from the learning process, namely, campus advisory pedagogy and interactive learning experiences.

Due to the rapid advancement of artificial intelligence and network technology, as will be described, several advanced technologies can be leveraged to reform traditional education and the current online learning system. To this end, various embodiments are disclosed herein that provide a reformed education system that facilitates any individual student to pursue its education with a personalized and customized learning experience according to an aptitude of the individual among other factors.

Accordingly, various embodiments are disclosed for generating personalized learning experiences using artificial intelligence and disparate data sources. A computing environment can include at least one computing device directed or configured to identify objectives for a user profile to meet in association with a learning course, identify learning resources associated with the learning course, identify information associated with the user profile, and invoke an artificial intelligence routine using the information associated with the user profile, the learning resources, and the objectives that generates a customized course for the user profile. The customized course for the user profile can be different than courses customized for other user profiles. The at least one computing device can present the customized course in a user portal for the user profile, which can include a student portal for a student user profile. The customized course as generated can include a subset of the learning modules curated for the user profile, as well as an order to complete the learning modules.

The embodiments described herein have the ability to fundamentally change the education system from curriculum-centric to student-centric. The philosophy of the embodiments described herein is to provide any student with a personalized learning experience according to his or her own goals, conditions, and aptitudes, allow him or her to achieve the set goals effectively and efficiently, etc. Unlike other existing online learning solutions, the embodiments described herein provide a student with a customized learning experience via an expert advisory service and enables the student to access unrestricted resources from a multi-channel resource library.

Throughout course selection, learning, and the developmental process of students, a human expert/artificial intelligence-based advisory service, referred to herein as an expert advisory service, can assist a student set achievable goals based on his/her vision, current knowledge, and aptitude, advise the student choosing the most suitable courses, etc. The expert advisory service can provide the student with feedback and suggestions based on his or her progress. The expert advisory helps the student secure a practical approach to set goals, choose a learning direction, and select the most relevant resources to assist the learning.

The educational resource library provides a student with the most relevant resources within the system or allows him/her to access educational resources owned by other partners/platforms via a multi-channel partnership. As such, the embodiments described herein leverage high-tech solution to provide seamless access for a student. For the sake of transparency, a student can be notified whether required resources are provided by its system or external systems. Based on a scalable technical architecture, an educational resource library, referred to herein as a boundless library service, can be easily and arbitrarily expanded or reduced. The educational resource library described herein can accommodate any online or offline educational resources as well.

In the following discussion, a general description of the system and its components is provided, followed by a discussion of the operation of the same.

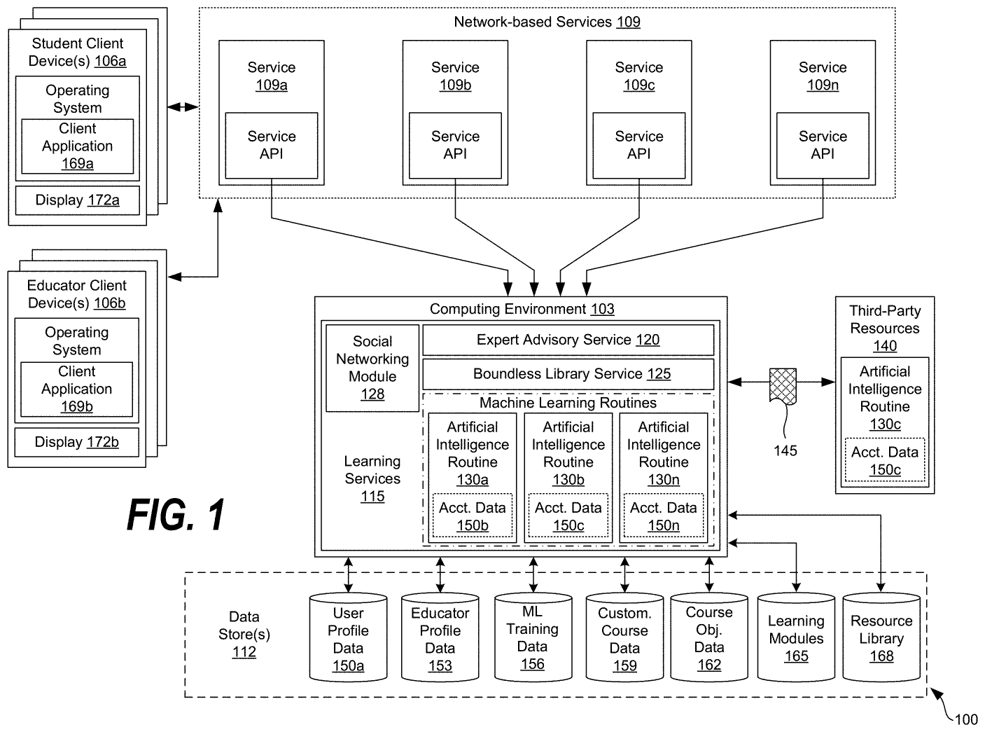

With reference to FIG. 1, shown is a networked environment 100 according to various embodiments. The networked environment 100 includes a computing environment 103, client devices 106a, 106b (collectively “client devices 106”), and network-based services 109, which are in data communication with each other via a network. The network includes, for example, the Internet, intranets, extranets, wide area networks (WANs), local area networks (LANs), wired networks, wireless networks, or other suitable networks, etc., or any combination of two or more such networks. For example, such networks can include satellite networks, cable networks, Ethernet networks, and other types of networks.

The computing environment 103 can include, for example, a server computer or other system providing computing capability. Alternatively, the computing environment 103 can employ a plurality of computing devices that can be arranged, for example, in one or more server banks or computer banks or other arrangements. Such computing devices can be located in a single installation or can be distributed among many different geographical locations. For example, the computing environment 103 can include a plurality of computing devices that together can include a hosted computing resource, a grid computing resource, and/or any other distributed computing arrangement. In some cases, the computing environment 103 can correspond to an elastic computing resource where the allotted capacity of processing, network, storage, or other computing-related resources can vary over time.

Various applications and/or other functionality can be executed in the computing environment 103 according to various embodiments. Also, various data is stored in a data store 112 that is accessible to the computing environment 103. The data store 112 can be representative of a plurality of data stores 112 as can be appreciated. The data stored in the data store 112, for example, is associated with the operation of the various applications and/or functional entities described below.

The components executed on the computing environment 103, for example, include various learning services 115. In some embodiments, the learning services 115 include an expert advisory service 120, a boundless library service 125, a social networking module 128, and other applications, services, processes, systems, engines, or functionality not discussed in detail herein. The learning services 115, or other service executed in the computing environment 103, can be accessed via one or more of the network-based services 109. For instance, a client device 106 can invoke a network-based service 109 to access data from the data store 112, invoke the expert advisory service 120, invoke the boundless library service 125, or perform other similar function.

The expert advisory service 120 is executed to leverage artificial intelligence to provide a customized learning experience for a user. For instance, a user can create a user profile maintained by the computing environment 103. Various information can be stored in association with the user profile, such as competency data, personal conditions, educator-defined objectives specified by an educator profile using an educator portal, user-defined objectives specified by the user profile in a user portal, educator-defined conditions, user-defined conditions, educator-defined aptitudes, user-defined aptitudes, and so forth.

Accordingly, the expert advisory service 120 can identify objectives for a user profile to meet in association with a learning course. Thereafter, the expert advisory service 120 can identify learning resources associated with the learning course, as well as information associated with the user profile. The expert advisory service 120 can then spawn an artificial intelligence routine 130a . . . 130n for the user profile using the information associated with the user profile, the learning resources, and the objectives that ultimately generates a customized and/or personalized course for the user profile that best align a user profile with the objectives.

As can be appreciated, the customized course for the user profile can be different than courses customized for other user profiles and objectives, conditions, aptitudes, etc., can vary from user to user or, more specifically, from student to student. Finally, the expert advisory service 120 presents the customized course in a user portal for the user profile, where the customized course as generated includes a subset of various learning modules customized or curated for the user profile, as well as an order to complete the learning modules determined by the artificial intelligence routine 130.

The artificial intelligence routines 130 can include artificial neural network (ANN) routines, convolutional neural network (CNN) routines, deep learning routines, or other suitable machine learning routine. In some embodiments, the computing environment 103 can spawn a unique process or a thread, referred to as a virtual process, to execute the artificial intelligence routine 130 therein for a particular user profile. Upon completion of the artificial intelligence routine 130 (and a personalized learning experience being generated for a user profile), the process or thread can be terminated to free up computing resources, such as memory and central processing unit (CPU) resources. While the artificial intelligence routines 130 are shown as executing locally in the computing environment 103, in some embodiments, a third-party web service can be invoked through a network application programming interface (API) call to execute an artificial intelligence routine 130 remotely from the computing environment 103.

The boundless library service 125 is executed to identify learning resources associated with a course, a learning module, or other educational activity. For instance, an educator can use the educate client device 106b to access an educator portal. An educator can create a course, such as “Introduction to Spanish.” The educator can provide resources for the “Introduction to Spanish” course, such as textbooks, reading materials, dictionaries, audio and video files, etc. The boundless library service 125 can store these resources in the data store 112, where the expert advisory service 120 can determine which of the resources and/or an order of the resources to present to a user profile to create a personalized learning experience.

In some embodiments, the boundless library service 125 can identify or extrapolate keywords from the resources provided by the educator (e.g., from a syllabus, textbook, worksheets, or other provided resources). The boundless library service 125 can perform one or more queries on network-based databases over the network, such as Google® Scholar, to identify additional resources. In some embodiments, these additional resources are automatically added to the boundless library service 125. In alternative embodiments, these additional resources are first presented to an educator to determine whether to add the resources to the boundless library service 125. In some embodiments, the additional resources as retrieved can be assigned a score based on relevancy using known relevancy assignment score techniques. The additional resources can be ranked and presented to the educator, or those having a score above a predetermined threshold indicating a high relevance can be added to the boundless library service 125.

Additionally, in some embodiments, the boundless library service 125 is executed to access a first subset of learning resources from local memory of the computing environment 103 (e.g., data store 112 in embodiments in which the data store 112 is local memory of the computing environment 103), which can include resources provided by an educator as described above, or resources already stored by or retrieved by the boundless library service 125. Additionally, in some embodiments, the boundless library service 125 can access a second subset of learning resources from one or more third-party resources 140. The third-party resources 140 can include search engines, third-party network sites, network-based video platforms, news articles, various announcements, job postings, etc., as described above.

For instance, in some embodiments, the boundless library service 125 can perform an automated search automatically using at least one search engine that generates a plurality of search results. The search can be performed using search terms identified from the resources, course objectives, course description, or other course data, as well as information associated with the user profile. The second subset of the learning resources, referred to a third-party learning resources 145, can be identified from search results.

After the customized course for a user profile is generated through execution of the artificial intelligence routine 130, the computing environment 103 can present the customized course in an educator portal for access by an educator client device 106b. In some embodiments, the computing environment 103 can receive a modification of the customized course by an educator profile through the educator portal, where the customized course presented in a student portal for a student user profile includes the customized course as modified by the educator profile.

The social networking module 128 is executed to provide a social network that permits an educator, such as a teacher, and students to interact in an environment similar to an on-campus education environment. As such, the social networking module 128 can generate one or more user interfaces for participating in chat rooms, video conferences, forum discussions, editing and sharing profiles, etc. The social networking module 128 facilitates campus atmosphere while providing an interactive learning experience. Online learners can get pedagogical advice and share with each other like in a traditional school.

In some embodiments, the social networking module 128 can include a teacher-student classroom networking portal. First, a teacher can access the teacher-student classroom networking portal to open a class. Thereafter, the social networking module 128 can create a corresponding classroom, which can include a chat room, a forum, a video conference, etc. An educator (e.g., a teacher, a teacher advisor (TA), a resident adviser (RA)) and all students enrolled in the class are automatically included as members of this classroom. Finally, the classroom is an environment for teacher and students to communicate and discuss interactively. They can share learning experiences, questions, etc. via live video/audio talk plus text functions mostly resembling a single classroom. They can also upload and/or download video, audio, images, or text to classroom platform for sharing.

In some embodiments, the social networking module 128 can include a club networking portal. As such, a teacher or student can create or open a club, resembling an on-campus club with a mission, setup rules, etc. Next, a student or educator can use the club networking portal to invite other teachers or students to join the club. Upon accepting an invitation, a teacher or student can become a club member. A club member can conduct activities in the club. Some club examples are as follows: piano competitions, California Artist Association, Women in Computer Science, etc.

Further, in some embodiments, the social networking module 128 can include a showroom for live performance broadcasting portal. A user can open a showroom using the portal, and can publish a show schedule and promote the show in the built-in social network. The showroom can accept audience registration and registered users can watch a performance.

The data stored in the data store 112 includes, for example, user profile data 150, educator profile data 153, machine learning training data 156, customized course data 159, course objective data 162, learning modules 165, resource library 168, and potentially other data. The user profile data 150 can include information associated with a student, such as login authentication data, aptitude data, condition data, complete coursework data, as well as other data. The educator profile data 153 can include information associated with an educator (e.g., a teacher), such as courses taught, educator-defined objections and conditions, and similar data.

The artificial intelligence routines 130 require an initial set of data, called training data, to act as a baseline for generating a personalized learning experience for a user profile. Accordingly, machine learning training data 156 can include curated training set data (data that trains a machine learning model) as well as curated test set data (data that tests the trained model). When training using machine learning training data 156, an artificial intelligence routine 130 can generate weights that are assigned to various factors, such as aptitude metrics for a user profile, course difficulty metrics, and other metrics. The weights are later used in generating customized course data 159 for a user profile. Learning modules 165 can include learning resources for a course, course videos, course tutorials, as well as other learning resources.

The client devices 106 can include a student client device 106a, an educator client devices 106b, as well as other devices that are representative of a plurality of client devices 106 that can be coupled to the network. The client devices 106 can include, for example, a processor-based system such as a computer system. Such a computer system can be embodied in the form of a desktop computer, a laptop computer, personal digital assistants, cellular telephones, smartphones, set-top boxes, music players, web pads, tablet computer systems, game consoles, electronic book readers, or other devices with like capability. The client devices 106 can include a display 172. The display 172 can include, for example, one or more devices such as liquid crystal display (LCD) displays, gas plasma-based flat panel displays, organic light emitting diode (OLED) displays, electrophoretic ink (E-ink) displays, LCD projectors, or other types of display devices, etc.

The client devices 106 can be configured to execute various applications such as a client application 169 and/or other applications. The client application 169 can be executed in a client devices 106, for example, to access network content served up by the computing environment 103 and/or other servers, thereby rendering a user interface on the display 172. To this end, the client application can include, for example, a browser, a dedicated application, etc., and the user interface can include a network page, an application screen, etc. The client devices 106 can be configured to execute applications beyond the client application 169 such as, for example, email applications, social networking applications, word processors, spreadsheets, and/or other applications.

Next, a general description of the operation of the various components of the networked environment 100 is provided. To begin, an educator uses an educator client device 106b to create a course, such as “Foundations of Algebra.” The educator can create objectives associated with the course, which is stored as course objective data 162. The objectives can include, for example, “defining set, subset, intersection, union, and the empty set,” “writing a set using set notation,” “indicating whether a given value is an element of a set,” “indicating whether a given set is a subset of another set,” and so forth.

In some embodiments, the educator can define objectives for particular user profiles (e.g., customized for individual learners) or, in alternative embodiments, the educator can define objectives that are applicable to all students enrolled in a course. Further, the educator can provide various learning resources, which can include textbooks, tutorials (e.g., series of network pages that teach a skill), homework, handouts, outlines, work sheets, etc.

Next, the computing environment 103 can identify the objectives for a user profile to meet in association with a learning course, such as those defined by the administrator as described in the example above, as well as the learning resources associated with the learning course. Further, the computing environment 103 can identify information associated with the user profile.

The computing environment 103 can provide the foregoing as inputs to an artificial intelligence routine 130 that has been trained. In other words, the computing environment 103 can execute an artificial intelligence routine 130 using the information associated with the user profile, the learning resources, and the objectives, and other information, where the artificial intelligence routine 130 generates a customized course for the user profile. As can be appreciated, the customized course for the user profile can be different than courses customized for different user profiles. The computing environment 103 can present the customized course in a user portal for the user profile, where the customized course as generated includes an order and a subset of the learning modules.

After the customized course for the user profile is generated through execution of the artificial intelligence routine 130, the computing environment 130 can present the customized course in an administrator portal. The computing environment 130 can then receive a modification of the customized course by an administrator profile through the administrator portal, where the customized course presented in the user portal for the user profile includes the customized course as modified by the administrator profile.

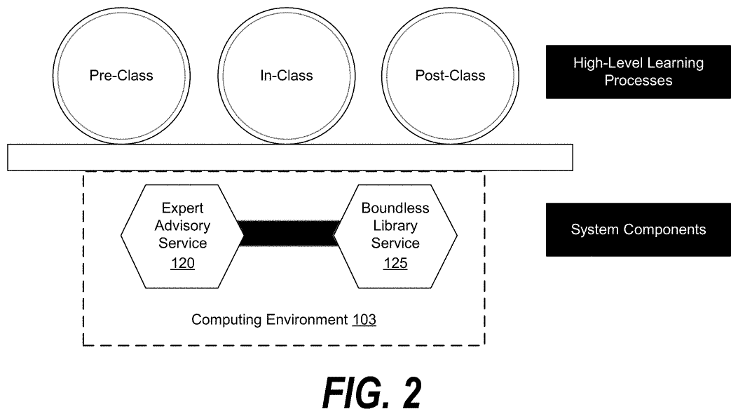

Referring next to FIG. 2 a schematic diagram is shown that includes a high-level overview of embodiments of the computing environment 103 that can support a student's general pre-class, in-class, and after-class processes. More specifically, FIG. 2 describes the general learning process including before, during, and after class. The components of the computing environment 103, such as the expert advisory service 120 and the boundless library service 125, can support a general learning process, and can be seamlessly connected with it and fully integrated, thus making it possible to tailor and teach students in accordance with their aptitude.

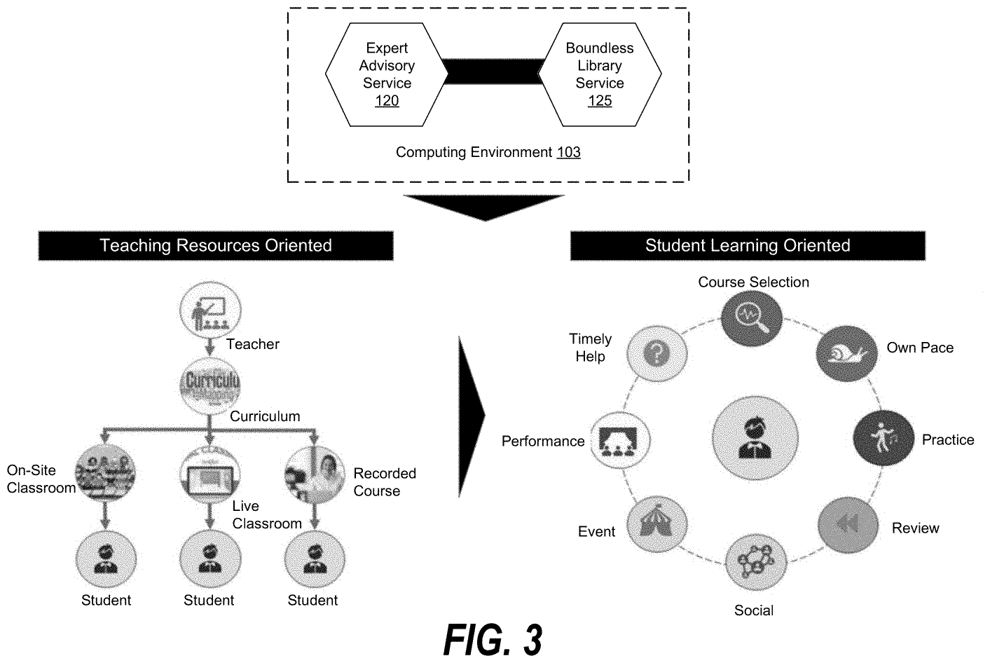

Turning now to FIG. 3, a schematic diagram is shown that displays differences between the existing state of education relative to the computing environment 103 described herein to disrupt the existing state. From the perspective of a traditional teaching model, previous teaching methods are centered on a teacher and a syllabus, and then the curriculum content was arranged to unify teaching. The embodiments described herein provide convenience to reasonably and effectively arrange limited teacher resources. However, each student is different and has his or her own unique characteristics, manifested in different comprehension abilities, different knowledge levels, different language preferences, different learning style preferences (different learning style), different learning pace preferences (different learning pace), different learning demands, and so on. Therefore, students must adapt to the teacher's rhythm more often, and over time, some students will lose their enthusiasm for learning.

The computing environment 103 described herein can be implemented to transform teacher- and syllabus-focused education to student-focused education, using artificial intelligence to make the impossible in the traditional teaching model possible. The student-focused teaching model can orient on different learning needs of students at various stages, including how to choose a course that suits them, how to achieve different learning rhythms, course content review, quality social networks, various possible performance opportunities, and so on.

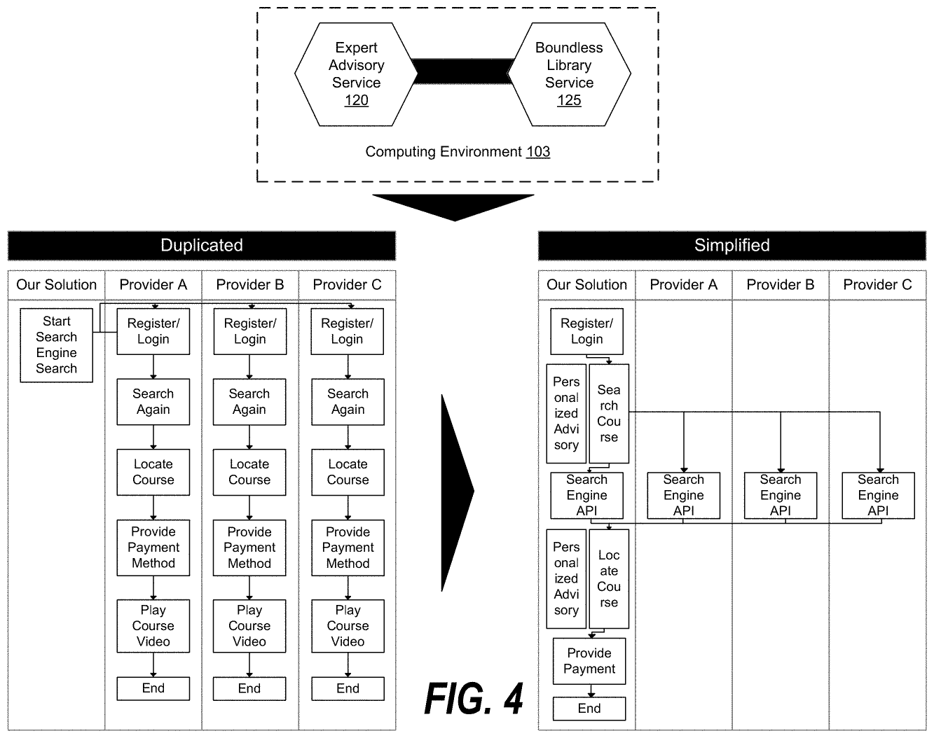

Moving on to FIG. 4, a schematic diagram is shown that highlights differences between the existing state of education relative to the computing environment in purchasing an online course. Traditionally, learners typically were required to go to a website that provides courses when choosing and purchasing courses. For instance, a learner would access a website, navigate to “register and log in,” navigate to “select courses,” provide payment information, and then begin learning. If one website cannot provide the required courses, you need to go to another website and repeat the above steps until the desired course is selected.

In accordance with the embodiments described herein, learners can choose their favorite courses without registering a profile (or an account) on each teaching website. The specific operation is that the learner completes the registration and login on a website that implements the boundless library service 125. When selecting a course, if the website cannot provide the desired course, the website will automatically search for his favorite course for the learner to other websites and complete the purchase on behalf of the learner. Therefore, the process steps for learners to choose and purchase courses online is shortened, providing a one-stop course selection mode.

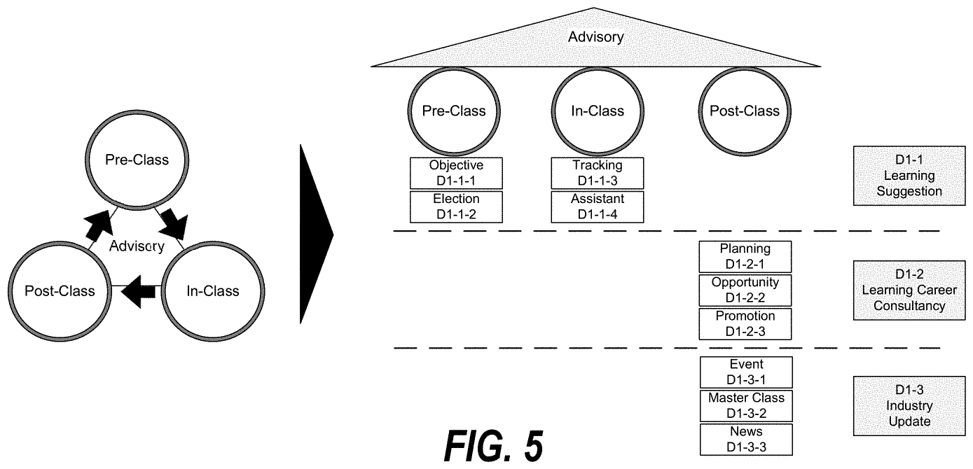

Referring next to FIG. 5, a schematic diagram is shown that provides an expert advisory service 120 being embedded in a general learning process and configured to provide a full range of services for students. FIG. 5 depicts the expert advisory service 120, which can be fully integrated into a general online learning process (e.g., before class, during class, and after class) to provide services for learners. Specifically, from the perspective of the process, before the class, the expert advisory service 120 can assist learners set their suitable learning goals (D1-1-1) and choose their favorite courses (D1-1-2). During the class, the expert advisory service 120 can provide learners with learning performance tracking (D1-1-3) and help in finding companionship/exercise (D1-1-4) and other consulting services. After class, the expert advisory service 120 can provide learners with career planning (D1-2-1), job opportunities (D1-2-2), how to promote/present their own works (D1-2-3) and other services. Other services include providing offline event/performance information push (D1-3-1), master class information push (D1-3-2), industry trends/news push (D1-3-3), etc. Table 1 is an index of various components of the expert advisory service 120.

TABLE 1

| | |
|---|---|
| D1 | Expert advisory |
| D1-1 | Learning support advice |
| D1-1-1 | Establish suitable learning goal/s |
| D1-1-1-1 | Determine the learner's goal/s |
| D1-1-1-2 | Collect learners' current skill level, language preference, |
| | learning style |
| D1-1-1-3 | Feedback evaluation results and give reasonable suggestions, |
| | including learning direction, learning goals, etc. |
| D1-1-2 | Course selection |
| D1-1-2-1 | Combining established learning goals, learners' current skill |
| | levels, language preferences, learning styles, etc., start |
| | screening tutors and related courses in the Education Resource |
| | Library |
| D1-1-2-2 | When filtering in the Education Resource Library, priority is |
| | given to matching in the built-in resource library. When the |
| | match is complete, you can directly access the resource |
| D1-1-2-3 | If the corresponding course cannot be matched in the built-in |
| | resource library, it will be matched in the cooperative resource |
| | library. When the match is complete, you can directly access |
| | the resource |
| D1-1-2-4 | If the corresponding course cannot be matched in the |
| | cooperative resource library, it will be matched in the |
| | external resource library. When the match is complete, you |
| | need to redirect to an external website to access the resource |
| D1-1-2-5 | If the corresponding course cannot be matched in the external |
| | resource library, if feasible, it will try to purchase offline |
| | educational resources |
| D1-1-3 | Study Performance Tracking |
| D1-1-3-1 | According to the established learning objectives, it is broken |
| | down into stage assessment indicators |
| D1-1-3-2 | Evaluation, and provide feedback suggestions |
| D1-1-3-3 | If necessary, adjust the learning objectives/progress |
| | appropriately |
| D1-1-4 | Provide escort/training information |
| D1-2 | Career Development Consulting |
| D1-2-1 | Career development planning advice |
| D1-2-2 | Job opportunity promotion |
| D1-2-3 | Works display/communication consulting |
| D1-3 | Industry News Push |
| D1-3-1 | Irregular offline event/performance information push |
| D1-3-2 | Unscheduled master class information push |
| D1-3-3 | News in other industries |
| D2 | Resource Library |
| D2-1 | What's included |
| D2-1-1 | Pre-recorded video lessons |
| D2-1-2 | Instructor information for online live courses |
| D2-1-3 | Professional related e-books |
| D2-1-4 | Online question bank |
| D2-1-5 | Relevant information to accompany/accompany readers |
| D2-2 | Content source classification |
| D2-2-1 | Self-owned |
| D2-2-2 | Partner |
| D2-2-3 | External links to non-partners |
| D2-2-4 | Offline resource collection library |
| D2-3 | Technology Architecture |
| D2-3-1 | Owned database |
| D2-3-2 | Partner API access |
| D2-3-3 | Nan-partner's external link redirection |
| D2-3-4 | Offline resource collection library index |
| D2-4 | Application scenario |
| D2-4-1 | Pre-recorded video course selection |
| D2-4-2 | Selection of online live courses and tutors |
| D2-4-3 | Extracurricular information inquiry/borrowing |
| D2-4-4 | Course review |
| D2-4-5 | Matching query for companion/student |

From the perspective of the types of services provided, the services provided by the expert advisory service 120 include learning assistance advice (D1-1), career development consulting (D1-2), and industry news push (D1-3). Exclusive consulting services can be provided entirely by humans, or entirely by artificial intelligence, or by a mixture of humans and artificial intelligence.

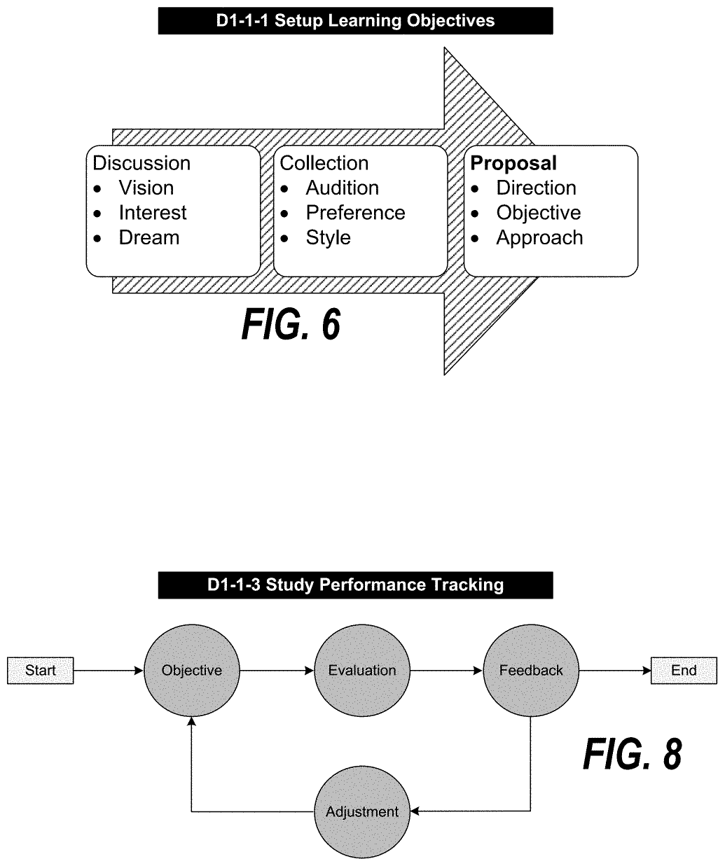

Turning now to FIG. 6, a schematic diagram is shown describing how the expert advisory service 120 helps learners set up their own learning goals/directions. FIG. 6 describes in detail how the expert advisory service 120 helps learners set learning goals (D1-1-1). In order to better find the learning direction/objective suitable for the learner, the advisor will discuss the learner's vision, interests, and dreams, and evaluate the current skill level, combined with their own learning style, learning preferences, etc. to set a customized learning goal.

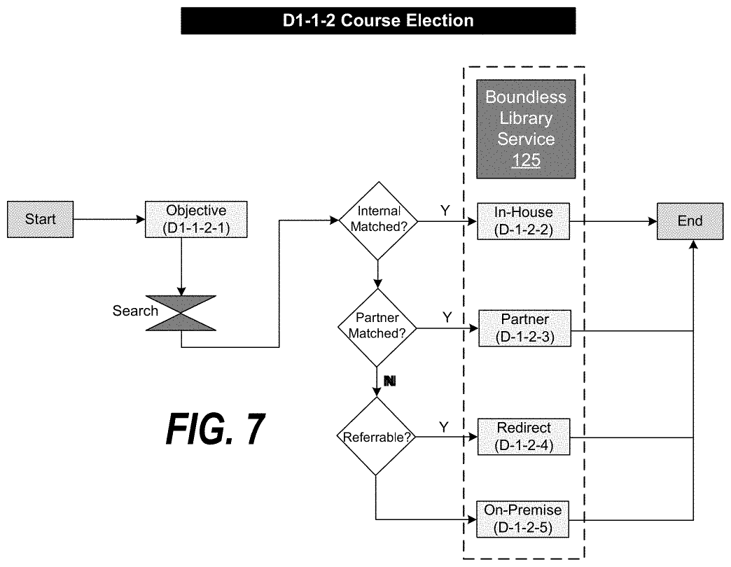

Moving along to FIG. 7, FIG. 7 explains in detail how the expert advisory system is combined with the resource library to perfectly help learners choose courses that suit them. Specifically, FIG. 7 describes how the expert advisory service 120 helps learners choose courses (D1-1-2) to provide one-stop service. According to the results of FIG. 6, advisors will give priority to searching for suitable courses in the database (D1-1-2-2) of this site. If they cannot be found, they will be in the database shared by the partner (D1-1-2-3) The expert advisory service 120 can interact with the boundless library service 125 to search internally. If a suitable course cannot be identified, the boundless library service 125 can search for the forwardable course link (D1-1-2-4) on the external Internet. If the boundless library service 125 still cannot locate a course, and cannot be found in an offline shop, then the boundless library service 125 can purchase a course online, for instance, in the database (D1-1-2-5).

Referring next to FIG. 8, FIG. 8 describes how the expert advisory system is implemented to monitor the learning progress. FIG. 8 describes the main activities of the expert advisory service 120 in providing learning performance tracking (D1-1-3) services. According to the set learning goals, it is broken down into stage assessment indicators (D1-1-3-1), and learners' performance is tracked and evaluated regularly, and certain feedback is given (D1-1-3-2). If deviations from expectations are found in the process, an alert can be generated and provided to an educator to discuss with the learner to see if additional efforts can be made to compensate for the deviations. If the deviations still cannot be compensated, the learning objectives can be adjusted (D1-1-3-3).

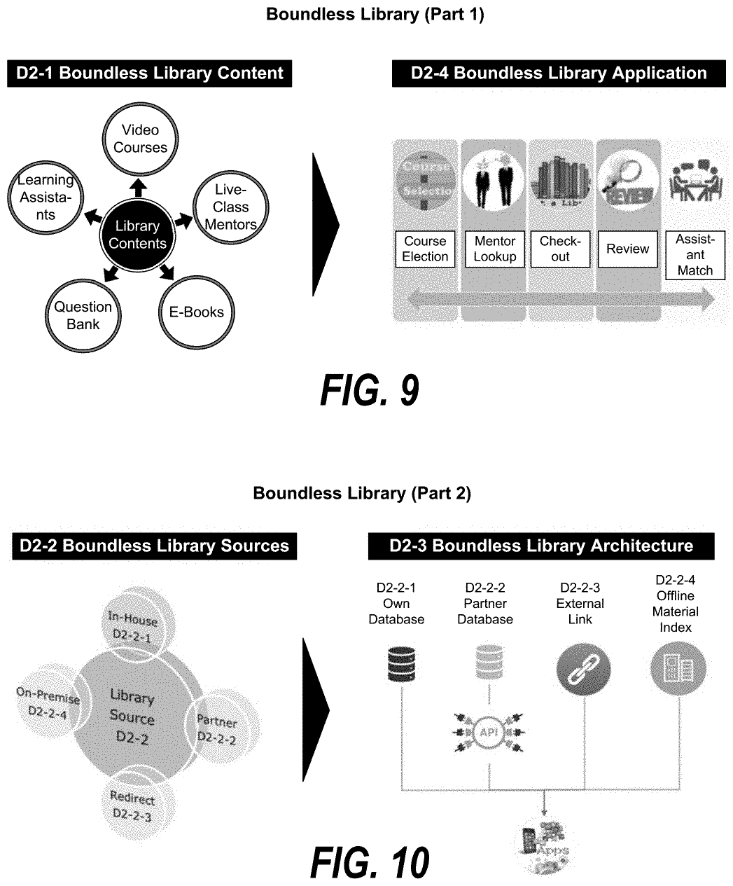

Turning now to FIG. 9, FIG. 9 describes what the resource library includes and some typical application scenarios of it. FIG. 9 describes the content of the resource library 168 and its application scenarios. The design concept of the boundless library service 125 is to provide learners with a centralized one-stop education resource. In the resource library 168, as much as possible is provided to learners with all the educational resources they need such as video tutorials (D2-1-1), tutor information for online live courses (D2-1-2), professional related electronic Books (D2-1-3), online forums (D2-1-4), and related information after class tutoring (D2-1-5). The application scenarios of the boundless library service 125 are also relatively wide, mainly including course selection (D2-4-1), tutor selection (D2-4-2), extracurricular information inquiry/borrowing (D2-4-3), and courses application scenarios, such as review (D2-4-4) and enquiry for tutoring practice (D2-4-5).

Moving on to FIG. 10, FIG. 10 summarizes a resource library 168 and its technical infrastructure. Specifically, FIG. 10 describes the source composition of the resource library 168 (D2-2) and its related technical architecture (D2-3). From the perspective of source composition, the resource library 168 includes self-owned (D2-2-1), partners (D2-2-2), external links of non-partners (D2-2-3), offline resource purchases and collections library (D2-2-4). The technical architecture of the resource library 168 (D2-3) can include its own database (D2-3-1), partner API access (D2-3-2), non-partner's external link redirection (D2)-3-3), offline resource collection library index (D2-3-4), and other data sources to communicate seamlessly with the computing environment 103. The above technical architecture can help resource library 168 to expand new data sources conveniently and flexibly at a relatively low cost.

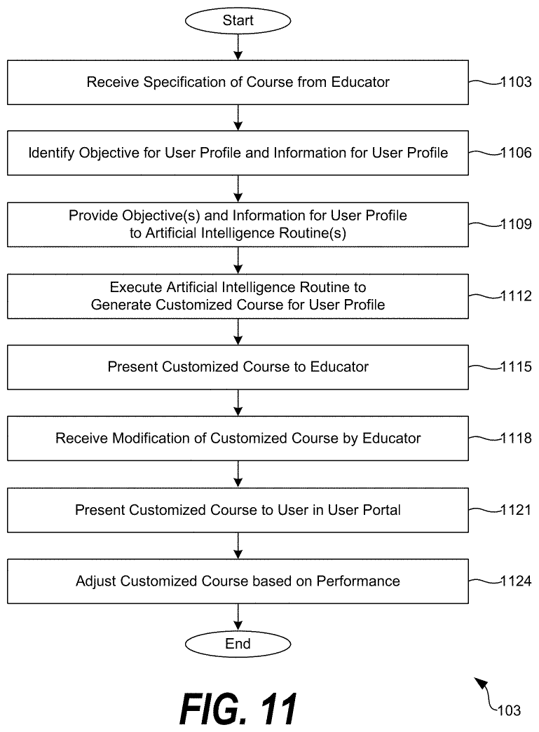

Referring next to FIG. 11, shown is a flowchart that provides one example of the operation of a portion of the computing environment 103 according to various embodiments. It is understood that the flowchart of FIG. 11 provides merely an example of the many different types of functional arrangements that can be employed to implement the operation of the portion of the computing environment 103 as described herein. As an alternative, the flowchart of FIG. 11 can be viewed as depicting an example of elements of a method implemented in the computing environment 103 by the expert advisory service 120 and/or the boundless library service 125 according to one or more embodiments.

Beginning with step 1103, the computing environment 103 can receive specification of a course. For instance an educator uses an educator client device 106b to create a course, such as “Foundations of Algebra.” The educator can create objectives associated with the course, which is stored as course objective data 162. The objectives can include, for example, “defining set, subset, intersection, union, and the empty set,” “writing a set using set notation,” “indicating whether a given value is an element of a set,” “indicating whether a given set is a subset of another set,” and so forth.

In some embodiments, the educator can define objectives for particular user profiles (e.g., customized for individual learners) or, in alternative embodiments, the educator can define objectives that are applicable to all students enrolled in a course. Further, the educator can provide various learning resources, which can include textbooks, tutorials (e.g., series of network pages that teach a skill), homework, handouts, outlines, work sheets, etc.

Next, in step 1106, the computing environment 103 can identify the objectives for a user profile to meet in association with a learning course, such as those defined by the administrator as described in the example above, as well as the learning resources associated with the learning course. Further, the computing environment 103 can identify information associated with the user profile.

The computing environment 103 in step 1109 can provide the foregoing as inputs to an artificial intelligence routine 130 that has been trained. In step 1112, the computing environment 103 can execute an artificial intelligence routine 130 using the information associated with the user profile, the learning resources, and the objectives, and other information, where the artificial intelligence routine 130 generates a customized course for the user profile. As can be appreciated, the customized course for the user profile can be different than courses customized for different user profiles.

In step 1115, after the customized course for the user profile is generated through execution of the artificial intelligence routine 130, the computing environment 130 can present the customized course to an educator via an educator portal. In step 1118, the computing environment 130 can then receive a modification of the customized course by an educator profile through the educator portal, where the customized course presented in the user portal for the user profile includes the customized course as modified by the educator profile.

Finally, in step 1121, the computing environment 103 can present the customized course in a user portal for the user profile, where the customized course as generated includes an order and a subset of the learning modules. In step 1124, the computing environment 103 can adjust the customized course based on performance of the user.

While FIG. 11 shows the modification of the customized course from the educator as being performed after the artificial intelligence routine is executed, in some embodiments, an initial course can be created by an educator, teacher, or other administrator, and modified using one or more of the artificial intelligence routines 130. Thereafter, the process can proceed to completion.

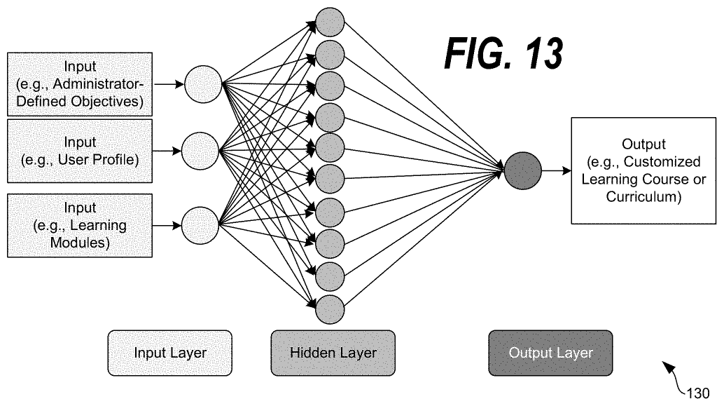

Skipping ahead to FIG. 13, FIG. 13 is a diagram that provides one example illustration of an artificial intelligence routine 130 that can be employed in the networked environment 100 of FIG. 1 according to various embodiments of the present disclosure. Specifically, the artificial intelligence routine 130 shown in FIG. 13 is an artificial neural network, which is a multi-layer, fully-connected neural network. The artificial neural network can include, for example, an input layer, multiple hidden layers, and an output layer. Each node in a layer can be connected to every other node in the next layer. The artificial neural network can be modified by increasing the number of hidden layers, for example. The inputs in the input layer can include administrator-defined objectives, a user profile (e.g., information pertaining to a student), learning modules 165, the resource library 168. The inputs can be quantified as metrics in some examples.

Each node can take a weighted sum of the inputs and pass the weighted sum through a non-linear activation function which can produce a node output. The node output is passed as an input to another node in the next layer, as can be appreciated. The final output (e.g., a customized or curated learning course or curriculum generated specifically for a user profile), can calculated by performing the non-linear activation function using the output of all the nodes. Training the artificial neural network can include learning and assigning weights associated with edges. In some embodiments, manually-curated data is used as training data. After the weights are learned or, in other words, after the machine learning routine 130 is trained, the machine learning routine 130 can be used.

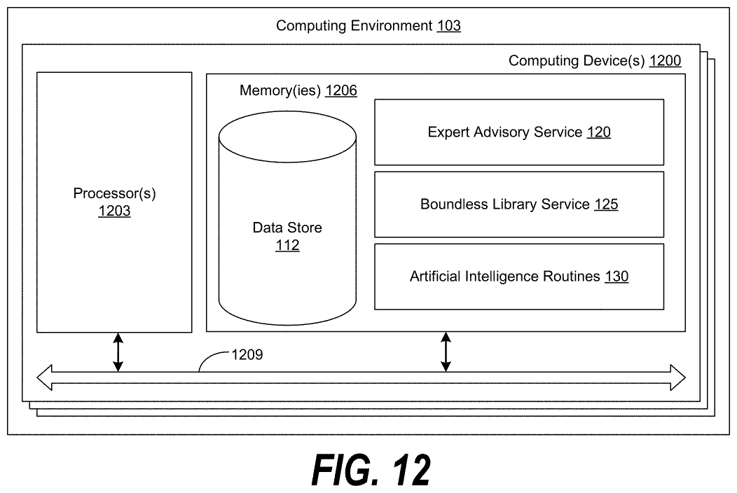

Turning back to FIG. 12, shown is a schematic block diagram of the computing environment 103 according to an embodiment of the present disclosure. The computing environment 103 includes one or more computing devices 1200. Each computing device 1200 includes at least one processor circuit, for example, having a processor 1203 and a memory 1206, both of which are coupled to a local interface 1209. To this end, each computing device 1200 can include, for example, at least one server computer or like device. The local interface 1209 can include, for example, a data bus with an accompanying address/control bus or other bus structure as can be appreciated.

Stored in the memory 1206 are both data and several components that are executable by the processor 1203. In particular, stored in the memory 1206 and executable by the processor 1203 are the expert advisory service 120, the boundless library service 125, the artificial intelligence routines 130, and potentially other applications. Also stored in the memory 1206 can be a data store 112 and other data. In addition, an operating system can be stored in the memory 1206 and executable by the processor 1203.

It is understood that there can be other applications that are stored in the memory 1206 and are executable by the processor 1203 as can be appreciated. Where any component discussed herein is implemented in the form of software, any one of a number of programming languages can be employed such as, for example, C, C++, C#, Objective C, Java®, JavaScript®, Perl, PHP, Visual Basic®, Python®, Ruby, Flash®, or other programming languages.

A number of software components are stored in the memory 1206 and are executable by the processor 1203. In this respect, the term “executable” means a program file that is in a form that can ultimately be run by the processor 1203. Examples of executable programs can be, for example, a compiled program that can be translated into machine code in a format that can be loaded into a random access portion of the memory 1206 and run by the processor 1203, source code that can be expressed in proper format such as object code that is capable of being loaded into a random access portion of the memory 1206 and executed by the processor 1203, or source code that can be interpreted by another executable program to generate instructions in a random access portion of the memory 1206 to be executed by the processor 1203, etc. An executable program can be stored in any portion or component of the memory 1206 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 1206 is defined herein as including both volatile and nonvolatile memory and data storage components. Volatile components are those that do not retain data values upon loss of power. Nonvolatile components are those that retain data upon a loss of power. Thus, the memory 1206 can include, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM can include, for example, static random access memory (SRAM), dynamic random access memory (DRAM), or magnetic random access memory (MRAM) and other such devices. The ROM can include, for example, a programmable read-only memory (PROM), an erasable programmable read-only memory (EPROM), an electrically erasable programmable read-only memory (EEPROM), or other like memory device.

Also, the processor 1203 can represent multiple processors 1203 and/or multiple processor cores and the memory 1206 can represent multiple memories 1206 that operate in parallel processing circuits, respectively. In such a case, the local interface 1209 can be an appropriate network that facilitates communication between any two of the multiple processors 1203, between any processor 1203 and any of the memories 1206, or between any two of the memories 1206, etc. The local interface 1209 can include additional systems designed to coordinate this communication, including, for example, performing load balancing. The processor 1203 can be of electrical or of some other available construction.

Although the expert advisory service 120, the boundless library service 125, the artificial intelligence routines 130, and other various systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIG. 11 shows the functionality and operation of an implementation of portions of the computing environment 103. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor 1203 in a computer system or other system. The machine code can be converted from the source code, etc. If embodied in hardware, each block can represent a circuit or a number of interconnected circuits to implement the specified logical function(s).

Although the flowcharts of FIG. 11 shows a specific order of execution, it is understood that the order of execution can differ from that which is depicted. For example, the order of execution of two or more blocks can be scrambled relative to the order shown. Also, two or more blocks shown in succession in FIG. 11 can be executed concurrently or with partial concurrence. Further, in some embodiments, one or more of the blocks shown in FIG. 11 can be skipped or omitted. In addition, any number of counters, state variables, warning semaphores, or messages might be added to the logical flow described herein, for purposes of enhanced utility, performance measurement, or providing troubleshooting aids, etc. It is understood that all such variations are within the scope of the present disclosure.

Also, any logic or application described herein, including the expert advisory service 120, the boundless library service 125, and the artificial intelligence routines 130, that includes software or code can be embodied in any non-transitory computer-readable medium for use by or in connection with an instruction execution system such as, for example, a processor 1203 in a computer system or other system. In this sense, the logic can include, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can include any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including, for example, static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein, including the expert advisory service 120, the boundless library service 125, and the artificial intelligence routines 130, can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device 1200, or in multiple computing devices in the same computing environment 103. Additionally, it is understood that terms such as “application,” “service,” “system,” “engine,” “module,” and so on can be interchangeable and are not intended to be limiting.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Therefore, the following is claimed:

1. A system for generating a personalized learning experience using artificial intelligence, comprising:
at least one computing device comprising at least one hardware processor; and
program instructions stored in memory and executable by the at least one hardware processor that, when executed, direct the at least one comprising device to:
identify a plurality of objectives for a user profile to meet in association with a learning course;
identify a plurality of learning resources associated with the learning course;
identify information associated with the user profile;
execute an artificial intelligence routine using the information associated with the user profile, the plurality of learning resources, and the plurality of objectives that generates a customized course for the user profile, the customized course for the user profile being different than courses customized for a plurality of other user profiles; and
present the customized course in a user portal for the user profile, wherein the customized course as generated comprises a subset of the plurality of learning modules curated for the user profile and an order assigned to the user profile to complete the plurality of learning modules in the subset.

2. The system of claim 1, wherein the artificial intelligence routine comprises one of an artificial neural network (ANN) routine, a convolutional neural network (CNN) routine, and a deep learning routine.

3. The system of claim 1, wherein the plurality of objectives comprise at least one of:
a plurality of educator-defined objectives specified by an educator profile using an educator portal;
a plurality of user-defined objectives specified by the user profile in a user portal;
a plurality of educator-defined conditions specified by an educator profile using an educator portal;
a plurality of user-defined conditions specified by the user profile in a user portal;
a plurality of educator-defined aptitudes specified by an educator profile using an educator portal; and
a plurality of user-defined aptitudes specified by the user profile in a user portal.

4. The system of claim 1, wherein the at least one computing device is further directed to:
after the customized course for the user profile is generated through execution of the artificial intelligence routine, present the customized course in an administrator portal; and
receive a modification of the customized course by an administrator profile through the administrator portal, wherein the customized course presented in the user portal for the user profile comprises the customized course as modified by the administrator profile.

5. The system of claim 1, wherein the plurality of learning resources associated with the learning course are identified by:
accessing a first subset of the plurality of learning resources from local memory of the at least one computing device; and
accessing a second subset of the plurality of learning resources from a third-party resource.

6. The system of claim 1, wherein accessing the second subset of the plurality of learning resources from the third-party resource comprises:
performing an automated search automatically using at least one search engine that generates a plurality of search results; and
identifying the second subset of the plurality of learning resources from the plurality of search results.

7. The system of claim 1, wherein the artificial intelligence routine is executed locally on the at least one computing device.

8. The system of claim 1, wherein the artificial intelligence routine is a third-party artificial intelligence routine invoked through an application programming interface (API) call made over a network.

9. The system of claim 1, wherein the at least one computing device is further directed to:
provide a networking module configured to permit at least one educator and at least one student to interact through at least one of: forum communications, video conferencing communications, or live chat communications.

10. The system of claim 1, wherein the artificial intelligence routine is invoked by an expert advisory service.

11. A computer-implemented method for generating a personalized learning experience using artificial intelligence, comprising:
identifying, by at least one computing device comprising at least one hardware processor, a plurality of objectives for a user profile to meet in association with a learning course;
identifying, by the at least one computing device, a plurality of learning resources associated with the learning course;
identifying, by the at least one computing device, information associated with the user profile;
invoking, by the at least one computing device, an artificial intelligence routine using the information associated with the user profile, the plurality of learning resources, and the plurality of objectives that generates a customized course for the user profile, the customized course for the user profile being different than courses customized for a plurality of other user profiles; and
presenting, by the at least one computing device, the customized course in a user portal for the user profile, wherein the customized course as generated comprises a subset of the plurality of learning modules curated for the user profile and an order assigned to the user profile to complete the plurality of learning modules in the subset.

12. The computer-implemented method of claim 11, wherein the artificial intelligence routine comprises one of an artificial neural network (ANN) routine, a convolutional neural network (CNN) routine, and a deep learning routine.

13. The computer-implemented method of claim 11, wherein the plurality of objectives comprise at least one of:
a plurality of educator-defined objectives specified by an educator profile using an educator portal;
a plurality of user-defined objectives specified by the user profile in a user portal;
a plurality of educator-defined conditions specified by an educator profile using an educator portal;
a plurality of user-defined conditions specified by the user profile in a user portal;
a plurality of educator-defined aptitudes specified by an educator profile using an educator portal; and
a plurality of user-defined aptitudes specified by the user profile in a user portal.

14. The computer-implemented method of claim 11, wherein the at least one computing device is further directed to:
after the customized course for the user profile is generated through execution of the artificial intelligence routine, present the customized course in an administrator portal; and
receive a modification of the customized course by an administrator profile through the administrator portal, wherein the customized course presented in the user portal for the user profile comprises the customized course as modified by the administrator profile.

15. The computer-implemented method of claim 11, wherein the plurality of learning resources associated with the learning course are identified by:
accessing a first subset of the plurality of learning resources from local memory of the at least one computing device; and
accessing a second subset of the plurality of learning resources from a third-party resource.

16. The computer-implemented method of claim 11, wherein accessing the second subset of the plurality of learning resources from the third-party resource comprises:
performing an automated search automatically using at least one search engine that generates a plurality of search results; and
identifying the second subset of the plurality of learning resources from the plurality of search results.

17. The computer-implemented method of claim 11, wherein the artificial intelligence routine is executed locally on the at least one computing device.

18. The computer-implemented method of claim 11, wherein the artificial intelligence routine is a third-party artificial intelligence routine invoked through an application programming interface (API) call made over a network.

19. The computer-implemented method of claim 11, further comprising providing a networking module configured to permit at least one educator and at least one student to interact through at least one of: forum communications, video conferencing communications, or live chat communications.

20. The computer-implemented method of claim 11, wherein the artificial intelligence routine is invoked by an expert advisory service.
